(19) United States
(12) Patent Application Publication
(10) Pub. No.: US 2002/0009541 A1
(43) Pub. Date: Jan. 24, 2002

(54) Method of improving the chemical resistance of carrier articles

(75) Inventor: Neil Clayton, Dillsboro, IN (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HOUGHTON FLUIDCARE INC., Lafayette, IN

(21) Appl. No.: 09/965,816

(22) Filed: Oct. 1, 2001

Related U.S. Application Data
(63) Continuation of application No. 09/558,295, filed on Apr. 25, 2000.

(51) Int. Cl. B05D 1/00

(52) U.S. Cl. 427/180

(57) ABSTRACT

A method of chemically treating a substrate metal article on a carrier metal article by chemically treating a substrate article on a carrier article, wherein the carrier article is coated with a non-electrically conducting coating.

### BACKGROUND OF THE INVENTION

1. Field of the Invention

The present invention relates to methods of improving the resistance of an article used as a carrier for a substrate article undergoing chemical treatment.

1. Background of the Invention

A major problem during the chemical treatment of metal articles is the buildup of chemical residue on the metal articles used as carriers for the substrate articles, i.e., chemical build-up on the carrier. Another problem is that the treatment chemicals may damage the carrier during application to the substrate article. While it is possible to wash such chemical build-up from the carrier articles, doing so can be prohibitively expensive and may require disposal of toxic materials. In addition, the residue from the washing operation, i.e., wash drippings, may interfere with subsequent coating operations.

Accordingly, improved methods of reducing chemical build-up on the carrier and/or making the carrier more resistant to chemical damage are extremely desirable.

### SUMMARY OF THE INVENTION

The present invention is based on the Inventor's discovery that carrier metal articles can be coated with a non-electrically conductive coating, thereby rendering the coated carrier less susceptible to chemical build-up or chemical degradation during the chemical treatment of substrate articles that are placed on the carrier.

Accordingly, the present invention provides a method of chemically treating a substrate metal article on a carrier metal article, comprising:

chemically treating a substrate article on a carrier article, wherein the carrier metal article is coated with a non-electrically conducting coating.

The present invention also provides a method of improving the chemical resistance of an article used as a carrier for a substrate article undergoing chemical treatment, comprising:

applying a non-electrically conducting coating to the surface of a carrier article;

placing a second metal article on the carrier article; and

chemically treating the substrate article.

A more complete appreciation of the invention and many of the attendant advantages thereof will be readily obtained as the same becomes better understood by reference to the following detailed description.

### DETAILED DESCRIPTION OF THE INVENTION

As used herein, the term “carrier” refers to an article used to hold the “substrate” article during the time the substrate is undergoing chemical treatment. The expression “improving the chemical resistance” of the carrier article refers to treating the carrier, e.g., by coating, so as to decrease the amount of chemical build-up on the carrier article during treatment of the substrate article and/or rendering the carrier article less susceptible to chemical degradation by the agents used to treat the substrate article. The coating may also provide enhanced abrasion resistance. The coating may also provide a non-stick surface, i.e., a surface having a low surface tension,

The chemical composition of the carrier and substrate articles is not particularly limited. The carrier articles are constructed of electrically conductive, mechanically strong material. Carrier articles may be constructed of forged or welded steel, cast iron, various metal alloys, or any combination of these. The material of construction preferably withstands exposure to temperatures between ambient and 700° F. without significant distortion or degradation. In a preferred embodiment, both the carrier and substrate are metal. An example of a preferred metal is steel.

The identity of the carrier may vary widely. Examples of suitable carriers include E-coat skids, body carriers, paint line parts racks, paint line and E-coat hooks. Note that some “carriers” may not literally carry substrate articles but may be equipment ancillary to the “chemical treatment operation”. Examples are: painting fixtures, paint and E-coat area stairs and walkway grates, dip tanks, paint booth wall panels and filter frames.

The identity of the substrate article may vary widely. Examples of suitable substrates include any metal substrate item to which a liquid or powder paint or coating is to be electrostatically applied during fabrication. Examples of such substrates include truck and car bodies, truck frames, engine, drive train, exhaust components, suspension components, trim pieces, heavy equipment components, motorsports equipment, exercise and athletic equipment, steel furniture, appliances, and cookware.

In the present invention, the carrier article is coated with a non-electrically conductive coating. The coating may prevent the accumulation of chemicals, e.g., paint, on the carrier during chemical treatment of the substrate article. The coating may also render the exposed surface of the carrier less susceptible to degradation by the chemicals used to treat the substrate article.

The coated carriers of the present invention are useful in a variety of procedures for treating the substrate articles. For example, the carriers may be used for painting, e-coating or washing the substrate article. The invention may also prove beneficial when substrate items are not electrostically charged, but the non-stick, chemically resistant properties are required. Operations such as dry film application, metal powder application, painting, acid etching and adhesive application may benefit from the invention. Note that in many cases the chemical treatment operation may include drying or curing ovens. As one skilled in the art will readily appreciate, when the carrier is used with electrostatic equipment and it is desired to provide a ground through the carrier, a portion of the carrier surface which is in contact with the substrate is not coated with the coating material.

The nature of the coating material is not particularly limited. The choice of coating will be a function of the requirements and priorities of the coating for the carrier, e.g., one coating may be more mechanically durable but less chemically resistant than another. In a preferred embodiment the coating material contains a fluoropolymer. The fluoropolymer may be a homopolymer of fluorinated monomers, a copolymer of two or more fluorinated monomers, or a copolymer of at least one fluorinated monomer and at least one non-fluorinated monomer. An example of a fluorinated monomer is chlorotrifluoroethylene. An example of a non-fluorinated monomer is ethylene. The coating material may contain a fluoropolymer and one or more non-fluorinated polymers.

Examples of suitable coating materials include ethylene chlorotrifluoroethylene (ETCFE), ethylene tetrafluoroethylene (ETFE) and perfluoroalkoxy (PFA). These materials are widely available as is well-known by those of skill in the art.

An especially preferred coating material is HALAR fluoropolymer. HALAR is essentially a 1:1 alternating copolymer of ethylene and chlorotrifluoroethylene. The polymer contains about 80% by weight of chlorotrifluoroethylene. HALAR is available from Ausimont (Thorofare, N.J.).

Another example of a preferred coating material is TefZel®. This material is a fluorpolymer resin available from DuPont. TefZel® is a modified ETFE fluoropolymer.

The coating on the carrier article should be thick enough to improve the resistance of the carrier surface to the chemicals used to treat the substrate article. The exact thickness of the coating may vary over a wide range, depending, as one skilled in the art would readily appreciate, on the nature of the carrier and the substrate. The coating may have a thickness of 0.002 to 0.02 inch, with a preferred range of 0.008 to 0.010 inch (8 to 10 mils). These ranges for the thickness of the coating include all specific values and subranges therebetween, such as 0.005, 0.0075, 0.0125, 0.015 and 0.0175 inches.

The coating may be applied in one layer or in multiple layers. Thus, the coating may be composed of two, three, four, five, or more layers.

The process used to coat the carrier article may vary widely. The coating may be applied at a specialized facility equipped with the application equipment and curing ovens required for compliance with the coating manufacturer's guidelines. Also specialized material handling equipment and fixtures must be available for manipulation of the carrier articles within the coating facility.

The following technique is used for Halar, and is representative of other materials. The carrier article is heated in an oven. When it reaches target temperature, the carrier is removed from the oven and a layer of powder applied prime coat is applied while the carrier is still hot. The carrier is immediately re-inserted into the oven. As the carrier is heated, the powder flows over the carrier to form a uniform layer. When it again reaches target temperature, the carrier is removed from the oven and a second layer of primer powder is applied. The carrier is immediately re-inserted into the oven. This cycle is repeated twice for the final coats of clear coat powder. After the final powder application, the carrier is placed into the oven and allowed to reach and remain at the target temperature until cured. After curing, the coated carrier is removed from the oven and allowed the cool naturally to ambient temperature.

If the carrier has previously been used in operations without the coating of the present invention, it may be necessary to remove paint and/or other materials which may have built-u during operations. These materials may be removed by any of the methods well-known to those skilled in the art, e.g., by sandblasting.

The application techniques for coatings other than Halar may vary in number of layers, temperature requirements, and other details, based upon the well-recognized differences in handling the coating starting materials.

The methods of the present invention are particularly useful in automobile assembly. In such a method the carrier article may be a paint skid or J-hook used to carry an automobile body through the assembly process. When the carrier is, for example, a paint skid, the present invention provides the following advantages:

(1) provide a stick-resistant surface to reduce the adhesion of customer-applied coatings to the paint skids and facilitate the washing of the paint skids;

(2) provide an electrically non-conductive surface over the paint skids to reduce the affinity of customer-applied electrostatic coatings to the paint skids (points at which electrical contact is required will be masked such that coating will not be applied);

(3) bond securely to the paint skids such that the proprietary coating remains affixed to the paint skids over time;

(4) be durable against the impacts and abrasions expected through normal cycling of the paint skids; and

(5) be chemically resistant to the chemical attack of customer-applied coatings and washing solutions.

### EXAMPLES

Having generally described this invention, a further understanding can be obtained by reference to certain specific examples which are provided herein for purposes of illustration only and are not intended to be limiting unless otherwise specified.

### Example 1

Carriers, called E-coat skids, were used at a DaimlerChrysler assembly pant in Newark, Delaware to convey Dodge Durango SUV bodies through the phosphate wash and E-coat line. These skids were nominally 97-inches wide by 193-inches long by 32-inches tall and were constructed of welded structural steel. The Halar-coated skids were introduced into service and the performance of the coating was observed since installation of the coated skids. After two-to four-months of continuous service, negligible deposition of E-coat onto the skids had been observed. The use of hazardous solvent solutions to clean the skids, and the corresponding spent solvent disposal, has been eliminated since the introduction of the coated skids.

Obviously, numerous modifications and variations of the present invention are possible in light of the above teachings. It is therefore to be understood that within the scope of the appended claims, the invention may be practiced otherwise than as specifically described herein.

1. A method of chemically treating a substrate metal article on a carrier metal article, comprising:
chemically treating a substrate article on a carrier article, wherein the carrier article is coated with a non-electrically conducting coating.

2. The method of claim 1, wherein the carrier article and the substrate article are made of metal.

3. The method of claim 1, wherein the coating comprises a fluoropolymer.

4. The method of claim 3, wherein the fluoropolymer contains polymerized chlorotrifluoroethylene units.

5. The method of claim 3, wherein the fluoropolymer contains polymerized chlorotrifluoroethylene units and polymerized units derived from a non-fluorinated oleinic monomoer.

6. The method of claim 1, wherein the fluoropolymer is composed of polymerized chlorotrifluoroethylene and ethylene units.

7. The method of claim 3, wherein the fluoropolymer contains from 60 to 90% by weight of the polymerized chiorotrifluoroethylene units.

8. The method of claim 3, wherein the fluoropolymer contains from 75 to 85% by weight of the polymerized chlorotrifluoroethylene units.

9. The method of claim 6, wherein the fluoropolymer contains from 60 to 90% by weight of the polymerized chlorotrifluoroethylene units and 10 to 40% by weight of the polymerized ethylene units.

10. The method of claim 6, wherein the fluoropolymer contains from 75 to 85% by weight of the polymerized chlorotrifluoroethylene units and 15 to 25% by weight of the polymerized ethylene units.

11. The method of claim 1, wherein the coating comprises HALAR.

12. The method of claim 1, wherein the carrier article is a skid or J-hook.

13. The method of claim 1, wherein the substrate article is a body of a motor vehicle.

14. The method of claim 1, wherein the substrate article is a car body.

15. The method of claim 1, wherein said chemically treating comprising painting, e-coating or washing the substrate article.

16. A method of improving the chemical resistance of an article used as a carrier for a substrate article undergoing chemical treatment, comprising:
applying a non-electrically conducting coating to the surface of a carrier article;
placing a second metal article on the carrier article; and
chemically treating the substrate article.

17. The method of claim 16, wherein the carrier article and the substrate article are made of metal.
